(19) United States
(12) Patent Application Publication
(10) Pub. No.: US 2017/0255450 A1
(43) Pub. Date: Sep. 7, 2017

(54) SPATIAL COOPERATIVE PROGRAMMING LANGUAGE

(71) Applicant: DAQRI, LLC, Los Angeles, CA (US)

(72) Inventors: Brian Mullins, Sierra Madre, CA (US); Matthew Kammerait, West Hollywood, CA (US)

(21) Appl. No.: 15/061,865

(22) Filed: Mar. 4, 2016

(51) Int. Cl. G06F 9/44; G06T 19/00

(52) U.S. Cl. CPC G06F 8/315; G06T 19/006

(57) ABSTRACT

A system and method for a mixed reality, spatial, cooperative programming language is described. A sensor of a device detects a first physical object and a second physical object. An augmented reality application identifies the first and second physical objects and a physical state of the first and second physical objects, generates a programming logic associated with the identification and physical state of the first and second physical objects, generates augmented or virtual reality information related to the programming logic, and displays the augmented or virtual reality information in the display.

### TECHNICAL FIELD

The subject matter disclosed herein generally relates to the visualization of programming language. Specifically, the present disclosure addresses systems and methods for an augmented or virtual reality spatial, cooperative programming language.

### BACKGROUND

Computer programming languages enable users to create programs to control a computer. A user typical types a source code on a keyboard. A display connected to the keyboard displays the program language. Therefore, current visual programming relies on a completely virtual “palette” of tools and a completely virtual canvas.

Visual programming languages have been developed as an alternative to writing codes. A visual program language lets user create programs by manipulating programming elements on a graphical user interface rather than a textual user interface. A visual program language makes use of visual expression and spatial arrangements of text and graphic symbols. For example, boxes represent entities that are connected by arrows or lines to represent functional relationships. Examples of visual programming languages includes Microsoft® Visual Basic, Scratch from MIT that allow kids and non-programmers to leverage their existing skills. Visual programming language operates in a virtual space (e.g., a computer screen). As such, the user is immersed in a virtual environment and disconnected from the real world environment.

### BRIEF DESCRIPTION OF THE DRAWINGS

Some embodiments are illustrated by way of example and not limitation in the figures of the accompanying drawings.

FIG. 1 is a block diagram illustrating an example of a network environment suitable for a spatial cooperative programming language, according to some example embodiments.

FIG. 2 is a block diagram illustrating a first example embodiment of modules (e.g., components) of a mobile device.

FIG. 3 is a block diagram illustrating an example embodiment of a spatial cooperative programming language module.

FIG. 4 is a block diagram illustrating another example embodiment of a spatial visual programming module.

FIG. 5 is a block diagram illustrating an example embodiment of an augmented reality programming module.

FIG. 6 is a block diagram illustrating an example embodiment of a mobile device for use of spatial cooperative programming language.

FIG. 7 is a block diagram illustrating a first example embodiment of modules (e.g., components) of a server.

FIG. 8 is a block diagram illustrating an example embodiment of a server programming language module.

FIG. 9 is a flow diagram illustrating an example operation of a spatial cooperative programming language module.

FIG. 10 is a flow diagram illustrating a first example operation of a spatial cooperative programming language module.

FIG. 11 is a flow diagram illustrating a second example operation of a spatial cooperative programming language module.

FIG. 12 is a flow diagram illustrating a third example operation of a spatial cooperative programming language module.

FIG. 13A is a block diagram illustrating an example of an augmented reality display generated by spatial cooperative programming language module.

FIG. 13B is a block diagram illustrating a second example of an augmented reality display generated by a spatial cooperative programming language module.

FIG. 13C is a block diagram illustrating a third example of an augmented reality display generated by a spatial cooperative programming language module.

FIG. 13D is a block diagram illustrating a fourth example of an augmented reality display generated by a spatial cooperative programming language module.

FIG. 13E is a block diagram illustrating a fifth example of an augmented reality display generated by a spatial cooperative programming language module.

FIG. 14 is a block diagram illustrating components of a machine, according to some example embodiments, able to read instructions from a machine-readable medium and perform any one or more of the methodologies discussed herein.

FIG. 15 is a block diagram illustrating a mobile device, according to an example embodiment.

### DETAILED DESCRIPTION

Example methods and systems are directed to a spatial cooperative programming language for an augmented reality (AR) system. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of example embodiments. It will be evident, to one skilled in the art, however, that the present subject matter may be practiced without these specific details.

Visual programming is typically performed on a computer display. Current visual programming relies on a completely virtual “palette” of tools and a completely virtual canvas. Typically, a virtual environment (e.g., display monitor) is used to display abstract and/or loosely linked representations of spatial context (e.g., blocks diagrams or flow diagram displayed on a screen). By combining augmented reality (AR) with traditional visual programming, the spatial aspect of real-world objects or actions can be used to further enhance and visualize computer programming. AR visual programming can be incorporated into the logical benefits of visual programming to make programming much simpler and more intuitive. Furthermore, AR-enabled spatial programming allows users of the visual programs to interact with the real world objects based on their locations. The visual programs interact based on user-defined logic derived or based on location. Additionally, AR-enabled spatial programming provides a more intuitive, immersive environment than a virtual display on a screen since AR-enabled spatial programming combines virtual elements with physical elements in the real-world environment.

For example, using AR capabilities, representational elements can communicate key capabilities or limitations inherent in the functions, calls, classes, objects, libraries, etc. being used and allows for intuition-based understanding or learning of key concepts. This spatial UI displayed in relation to a spatial physical environment or physical objects using AR could be toggled on or off vs. a more traditional IDE or could be phased out as concepts are learned.

The present application describes a system and method for a spatial cooperative programming language using augmented or virtual reality. In one example embodiment, an optical sensor of a device captures an image at a first physical object and a second physical object. An augmented reality (AR) application in the device identifies the first and second physical objects and a physical state (e.g., orientation, position, location, context information) of the first and second physical objects. The AR application generates a programming logic (e.g., an operator or a function of a programming language) associated with the identification and physical state of the first and second physical objects. The AR application then generates AR information related to the programming logic and displays the AR information in the display.

In one example embodiment, a user creates a visual program to compare two physical objects. Instead of typing or selecting the objects from a list, the user identifies the exact objects using AR. In another example embodiment, the user creates a visual program to tie specific item actions to specific item interactions. For example, the user can physically indicate the different items and/or actions using gestures and spatial orientation. In another example embodiment, a user creates a visual program with logical comparisons. By using AR, the user can physically visualize the logic and identify bugs and incomplete features in a three-dimensional state in an augmented or mixed reality setting. In contrast, common visual programming operate in a two-dimensional state in a virtual environment disconnected from the physical environment of the user.

AR can be implemented in a mobile computing device (also referred to as a viewing device) using AR applications that allow a user to experience information, such as in the form of a virtual object (e.g., a three-dimensional model of a virtual dinosaur) overlaid on an image of a real world physical object (e.g., a billboard) captured by a camera of a viewing device. The mobile computing device may include a handheld device such as a tablet or smartphone. In another example, the mobile computing device includes a wearable device such as a head mounted device (e.g., helmet, glasses). The virtual object may be displayed in a transparent or clear display (e.g., see-through display) of the viewing device or a non-transparent screen of the viewing device. The physical object may include a visual reference (e.g., uniquely identifiable pattern on the billboard) that the AR application can recognize. A visualization of the additional information, such as the virtual object overlaid or engaged with an image of the physical object is generated in the display of the viewing device. The viewing device generates the virtual object based on the recognized visual reference (e.g., QR code) or captured image of the physical object (e.g., image of a logo). The viewing device displays the virtual object based on a relative position between the viewing device and the visual reference. For example, a virtual dinosaur appears closer and bigger when the viewing device is held closer to the visual reference associated with the virtual dinosaur. Similarly, the virtual dinosaur appears smaller and farther when the viewing device is moved further away from the virtual reference associated with the virtual dinosaur. The virtual object may include a three-dimensional model of a virtual object or a two-dimensional model of a virtual object. For example, the three-dimensional model includes a three-dimensional view of a chair. The two-dimensional model includes a two-dimensional view of a dialog box, menu, or written information such as statistics information for a baseball player. The viewing device renders an image of the three-dimensional or two-dimensional model of the virtual object in the display of the viewing device.

In another example embodiment, a non-transitory machine-readable storage device may store a set of instructions that, when executed by at least one processor, causes the at least one processor to perform the method operations discussed within the present disclosure.

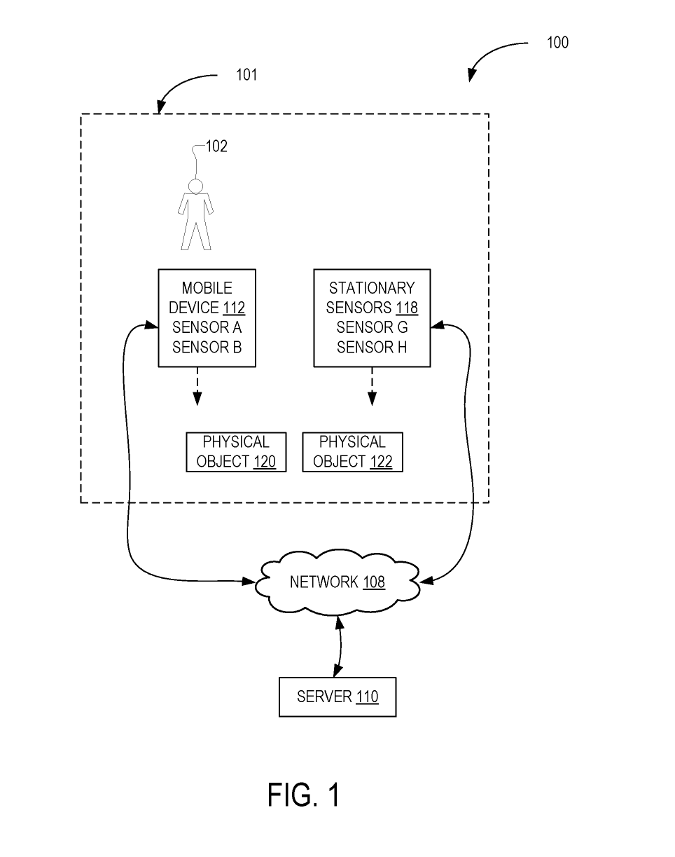

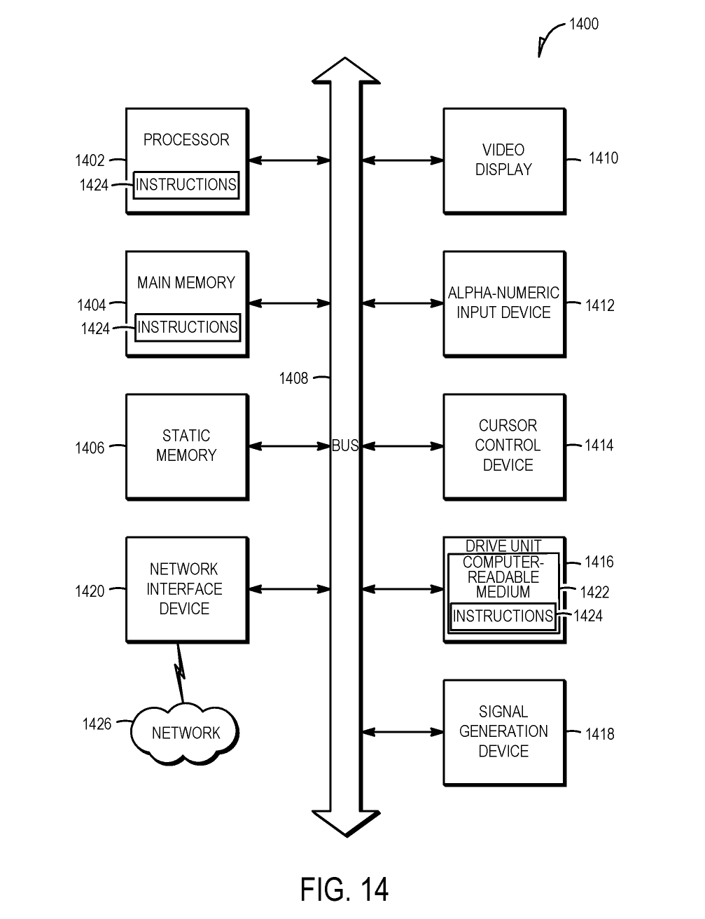

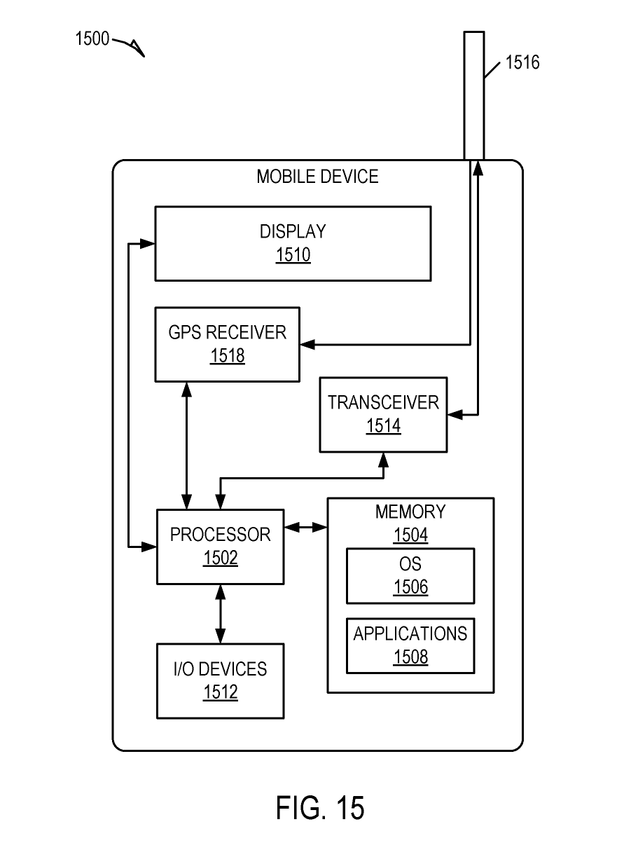

FIG. 1 is a block diagram illustrating an example of a network environment 100 suitable for a multi-spectrum segmentation for computer vision, according to some example embodiments. The network environment 100 includes a mobile device 112 (e.g., a laptop, a tablet, or any portable computing device), stationary sensors 118, and a server 110, communicatively coupled to each other via a network 108. The mobile device 112, the stationary sensors 118, and the server 110 may each be implemented in a computer system, in whole or in part, as described below with respect to FIG. 14 or in a mobile device as described with respect to FIG. 15. The server 110 may be part of a network-based system. For example, the network-based system may be or include a cloud-based server system that provides additional information, such as three-dimensional models of visual programming information, to the mobile device 112. The mobile device 112 and stationary sensors 118 are located in a contextual physical environment (e.g., a pre-identified room, a building, a specific location).

The mobile device 112 has a respective user 102. The user 102 may be a human user (e.g., a human being), a machine user (e.g., a computer configured by a software program to interact with the mobile device 112), or any suitable combination thereof (e.g., a human assisted by a machine or a machine supervised by a human). The user 102 is not part of the network environment 100, but is associated with the mobile device 112 and may be a user 102 of the mobile device 112. The mobile device 112 includes a computing device with a display such as a wearable computing device (e.g., helmet or glasses). In one example, the mobile device 112 includes a display screen (e.g., transparent, non-transparent, partially-transparent) that displays what is captured with a camera of the mobile device 112. In another example, a display of the mobile device 112 may be transparent such as in lenses of wearable computing glasses or a visor of a helmet. The mobile device 112 may be removably mounted to a head of the user 102. In another example, other computing devices that are not head mounted may be used instead of the mobile device 112. For example, the other computing devices may include handheld devices such as smartphones and tablet computers. Other computing devices that are not head mounted may include devices with a transparent display such as a windshield of a car or plane.

The mobile device 112 includes a set of sensors (e.g., sensors a and b). The sensors include for example, optical sensors of different spectrum ranges (UV, visible, IR), distance detecting range, or other types of sensors (e.g., temperature sensor). The sensors provide data about the environment and the user. For example, sensor a may include an optical camera and sensor b may include a depth/range sensor. Both sensors a and b are attached to the mobile device 112 and aimed in the same direction and share a same or similar field of view. The field of view is similar when, for example, the field of view of sensor a overlaps the field of view of sensor b by more than seventy five percent.

Stationary sensors 118 include stationary positioned sensors g and h that are static with respect to a physical environment 101 (e.g., a room). For example, stationary sensors 118 include an IR camera on a wall or a smoke detector in a ceiling of a room. Sensors in the stationary sensors 118 can perform similar functions (e.g., optical sensors) or different functions (e.g., measure pressure) from the sensor in the mobile device 112. In another embodiment, stationary sensors 118 may be used to track the location and orientation of the mobile device 112 externally without having to rely on the sensors internal to the mobile device 112. For example, the stationary sensors 118 may include optical sensors (e.g., depth-enabled 3D camera), wireless sensors (Bluetooth, WiFi), GPS sensors, and audio sensors to determine the location of the user 102 with the mobile device 112, distance of the user 102 to the stationary sensors 118 in the physical environment 101 (e.g., sensors placed in corners of a venue or a room), and/or the orientation of the mobile device 112, to track what the user 102 is looking at (e.g., direction at which the mobile device 112 is pointed, mobile device 112 pointed towards a player on a tennis court, mobile device 112 pointed at a person in a room). The mobile device 112 and corresponding user 102 may all be located within a same physical environment 101 (e.g., a building, a floor, a campus, a room).

The user 102 uses an AR application in the mobile device 112. The AR application provides the user 102 with augmented information in the form of information (e.g., virtual object) overlaid on an image of the physical objects 120 and 122, both located within a field of view of the mobile device 112 (and the stationary sensors 118). Examples of the physical objects include, but are not limited to, a two-dimensional physical object (e.g., a picture), a three-dimensional physical object (e.g., a block, a statue), and a user-manipulable physical object in the real-world physical environment 101. For example, the user 102 may point the mobile device 112 towards the physical objects 120, 122 and capture an image of the physical objects 120, 122. The physical objects 120, 122 in the image are tracked and recognized (e.g., identified) locally in the mobile device 112 using a local context recognition dataset of the AR application of the mobile device 112. The local context recognition dataset includes a library of predefined virtual objects associated with real-world physical objects 120 or references (e.g., a mapping of virtual objects and interactions to a physical object). The AR application then generates additional information (e.g., a three-dimensional model) corresponding to the image of the physical objects 120, 122 and presents this additional information in a display of the mobile device 112 in response to identifying the recognized image. In other embodiments, the additional information may be presented to the user 102 via other means such as audio or haptic feedback. If the captured image is not recognized locally at the mobile device 112, the mobile device 112 downloads additional information (e.g., the three-dimensional model related to a programming language) corresponding to the captured image, from a database of the server 110 over the network 108. In another example, the mobile device 112 and the stationary sensors 118 are aimed at the same physical objects 120, 122. The stationary sensors 118 are stationary with respect to the physical environment 101 and include, for example, a camera affixed a wall in the physical environment 101. The camera can pan, rotate, and tilt to follow and remain pointed at the physical objects 120, 122.

In one example embodiment, the computing resources of the server 110 may be used to determine and render virtual objects based on the tracking data (generated on the mobile device 112 using data from sensors 202 of the mobile device 112 or generated on the server 110 using data from stationary sensors 118). The rendering process of a virtual object is therefore performed on the server 110 and streamed to the mobile device 112. As such, the mobile device 112 does not have to compute and render any virtual object and may display the already rendered (e.g., previously generated) virtual object in a display of the corresponding mobile device 112.

In another example embodiment, the mobile device 112 (and the stationary sensors) identifies the physical objects 120, 122 and a physical state (e.g., orientation, position, location, context information, distance between them, an interaction between the physical objects, an interaction between the user and the physical objects, a movement of the physical objects, a direction of movement of the physical objects, a relative position between the mobile device 112, physical object 120, and physical object 122) of the physical objects 120, 122. The AR application generates a programming logic (e.g., an operator or a function of a programming language) associated with the identification and physical state of the physical objects 120, 122. In another example, the user chooses a programming logic for the physical objects 120, 122 based on their physical state. The mobile device 112 then generates AR information related to the programming logic and displays the AR information in the display of the mobile device 112.

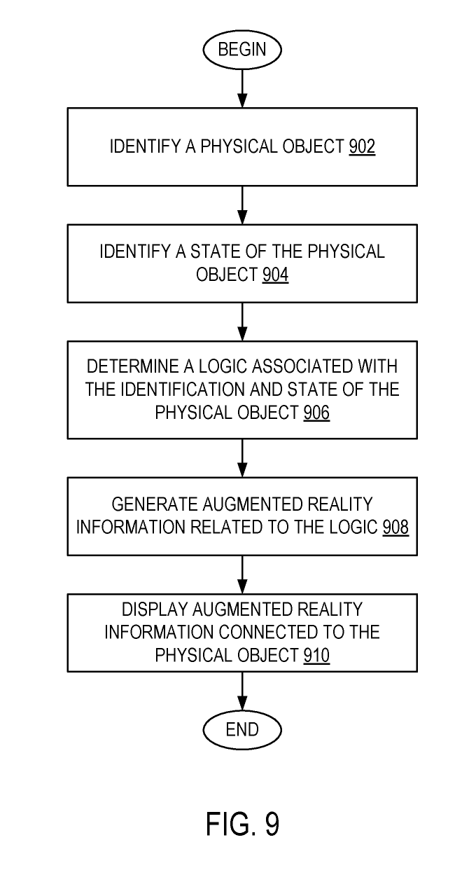

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIGS. 9-12. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., mobile device 112). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

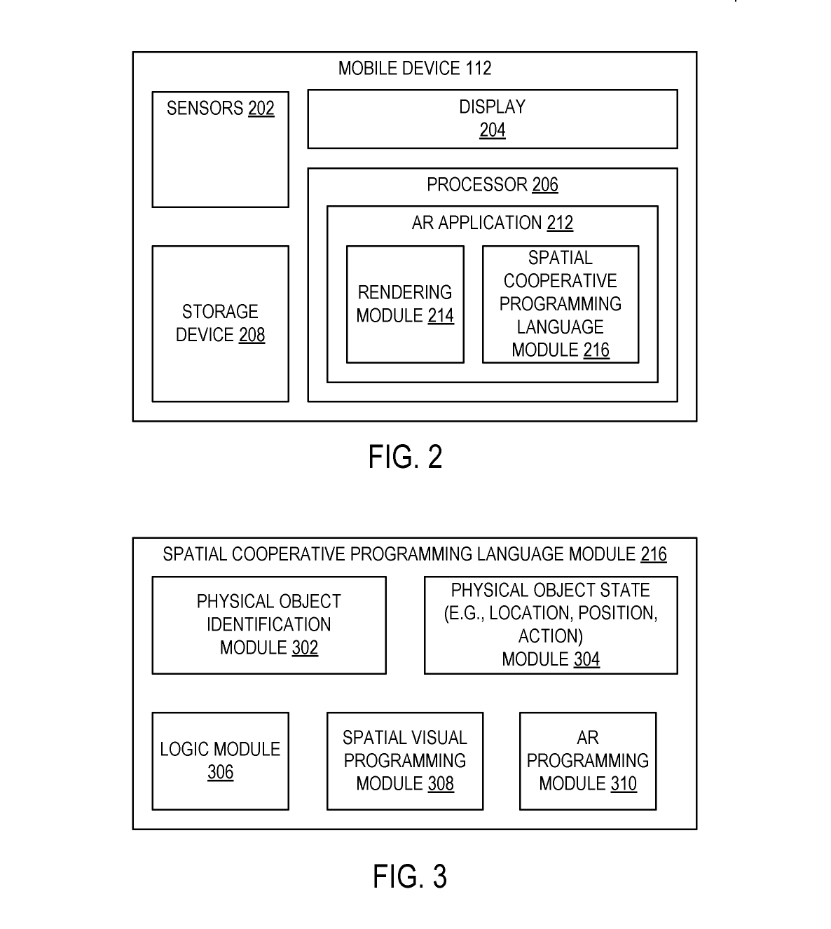

FIG. 2 is a block diagram illustrating a first example embodiment of modules (e.g., components) of the mobile device 112. The mobile device 112 may include sensors 202, a display 204, a processor 206, and a storage device 208. For example, the mobile device 112 may be a wearable computing device.

The sensors 202 include, for example, optical sensors of varying spectrum sensitivity—UV, visible, IR (e.g., depth sensor, IR sensor), a thermometer, a barometer, a humidity sensor, an EEG sensor, a proximity or location sensor (e.g., near field communication, GPS, Bluetooth, WiFi), an orientation sensor (e.g., gyroscope, IMU), an audio sensor (e.g., a microphone), or any suitable combination thereof. For example, the different optical sensors are positioned in the mobile device 112 to face a same direction. It is noted that the sensors 202 described herein are for illustration purposes and the sensors 202 are thus not limited to the ones described.

The display 204 includes, for example, a display (transparent, translucent, opaque, partially opaque, or non-transparent) configured to display images generated by the processor 206. In another example, the display 204 includes a touch sensitive surface to receive a user input via a contact on the touch sensitive surface.

The processor 206 includes an AR application 212 comprising a rendering module 214 and a spatial cooperative programming language module 216. The AR application 212 identifies the physical objects 120, 122 and their respective physical states (e.g., orientation, position, location, context information, distance between them, an interaction between the physical objects, an interaction between the user and the physical objects, a movement of the physical objects, a direction of movement of the physical objects, a relative position between the mobile device 112, physical object 120, and physical object 122) based on data from the sensors 202. The AR application 212 then retrieves, from the storage device 208, AR content associated with the identification of the physical objects 120, 122 and their physical states. In one example embodiment, the AR application 212 identifies a visual reference (e.g., a logo or QR code) on the physical object 120 and tracks the location of the visual reference within the display 204 of the mobile device 112. The visual reference may also be referred to as a marker and may consist of an identifiable image, symbol, letter, number, machine-readable code. For example, the visual reference may include a bar code, a quick response (QR) code, or an image that has been previously associated with the virtual object.

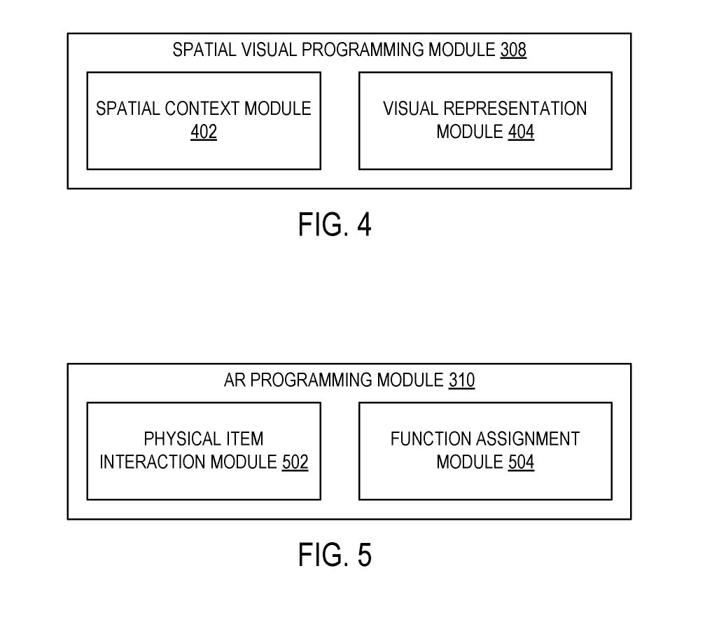

The spatial cooperative programming language module 216 combines augmented reality (AR) with traditional visual programming (e.g., programming by manipulating graphical elements on a display monitor). The spatial cooperative programming language module 216 identifies and determines spatial aspects of real-world objects (e.g., size, location, orientation, placement, shape, color) or actions (e.g., motion or rotation in a direction or along an axis) that can be used to further enhance and visualize computer programming (e.g., visual highlights to indicate functions or operations, connectors such as arrows, lines, arcs, spatial arrangement of augmented or virtual reality information such as text or graphical symbols). The spatial cooperative programming language module 216 generates a display of spatial visual programming using augmented or virtual reality to program and associate physical objects with virtual programming logic, operators, or functions. For example, the spatial cooperative programming language module 216 creates a visual program to compare two physical objects by having the user identify the physical objects using augmented or virtual reality (e.g., the user picks up two physical objects, one in each hand) instead of typing or selecting the objects from a list displayed on a screen monitor. In one example, the user may simply say the name of an object. The augmented reality application provides visual feedback by highlighting or pointing to the object. In another example, the spatial cooperative programming language module 216 creates a visual program that ties and associates specific item actions (e.g., perform comparison computation x based on database y and database z) to specific item interactions (e.g., when a first physical item associated with database y is stacked on top of a second physical item associated with database z). In another example, the spatial cooperative programming language module 216 enables the user to physically indicate the different items and/or actions (e.g., perform operation x) using gestures and spatial orientation (e.g., physical objects lined up in a row). In another example, the spatial cooperative programming language module 216 creates a visual program with logical comparisons by using AR so that the user can physically move around the logic and identify bugs and incomplete features (e.g., virtual arrows connect the physical objects, or visual indicators (visual links) showing missing connector or bad connection, missing data or bad link). The spatial cooperative programming language module 216 is discussed further with respect to FIGS. 3 and 4.

The rendering module 214 renders virtual objects based on augmented or virtual reality information provided by the spatial cooperative programming language module 216 or based on data from the sensors 202 processed by AR application 212. For example, the rendering module 214 displays augmented or virtual reality information (e.g., virtual box, highlight, connector, arrow, text, graphic) adjacent to the corresponding physical object (e.g., text of “computation engine” next to physical object 120, a virtual arrow connecting physical object 120 to physical object 122, a virtual highlight or box to emphasize the computation of an operation associated with a physical object, a virtual arrow showing a connection if the result of a decision block is yes or no). The rendering module 214 dynamically renders the augmented or virtual reality information based on the relative position of the physical objects. For example, the rendering module 214 dynamically adjusts a display of the connector (e.g., virtual arrow or visual link) between two physical objects even when the location or position of the physical objects has moved.

In another example embodiment, the rendering module 214 renders a display of a virtual object (e.g., a door with a color based on the temperature inside the room as detected by sensors 202 from the mobile device 112) based on a three-dimensional model of the virtual object (e.g., 3D model of a virtual door) associated with the physical object 120 (e.g., a physical door). In another example, the rendering module 214 generates a display of the virtual object overlaid on an image of the physical object 120 captured by a camera of the mobile device 112. In the example of a see-through display, no image of the physical object 120 is displayed. The virtual object may be further manipulated (e.g., by the user 102) by moving the physical object 120 relative to the mobile device 112. Similarly, the display of the virtual object may be manipulated (e.g., by the user 102) by moving the mobile device 112 relative to the physical object 120.

In another example embodiment, the rendering module 214 includes a local rendering engine that generates a visualization of a three-dimensional virtual object overlaid (e.g., superimposed upon, or otherwise displayed in tandem with) on an image of a physical object 120 captured by a camera of the mobile device 112 or a view of the physical object 120 in the display 204 of the mobile device 112. A visualization of the three-dimensional virtual object may be manipulated by adjusting a position of the physical object 120 (e.g., its physical location, orientation, or both) relative to the camera of the mobile device 112. Similarly, the visualization of the three-dimensional virtual object may be manipulated by adjusting a position of the camera of the mobile device 112 relative to the physical object 120.

In another example embodiment, the rendering module 214 identifies the (non-electric or non-electrically connected) physical object 120 (e.g., a particular pen) based on data from the sensors 202 (or from sensors in other devices), accesses virtual functions (e.g., increase or lower the volume of a nearby television) associated with physical manipulations (e.g., rotating the pen on a flat surface) of the physical object 120, and generates a virtual function corresponding to a physical manipulation of the physical object 120.

In another example embodiment, the rendering module 214 determines whether the captured image matches an image locally stored in the storage device 208 that includes a local database of images and corresponding additional information (e.g., three-dimensional model and interactive features). The rendering module 214 retrieves a primary content dataset from the server 110, generates and updates a contextual content dataset based on an image captured with the mobile device 112.

The storage device 208 stores identifiers (e.g., unique feature points, shapes, QR or base codes) associated with the physical objects 120, 122, their respective programming functions or operations, their respective graphical representation, their corresponding physical states. For example, the storage device 208 includes a database of programming functions and corresponding identification of physical objects and physical states. Pre-identified functions may be associated with a pre-identified physical object or a group of pre-identified physical objects. The pre-identified functions may further be associated with a physical spatial arrangement of the physical objects.

The storage device 208 further includes a database of visual references (e.g., images, visual identifiers, features of images) and corresponding experiences (e.g., three-dimensional virtual objects, interactive features of the three-dimensional virtual objects). For example, the visual reference may include a machine-readable code or a previously identified image (e.g., a picture of a cup). The previously identified image of the shoe may correspond to a three-dimensional virtual model of the shoe that can be viewed from different angles by manipulating the position of the mobile device 112 relative to the picture of the cup. Features of the three-dimensional virtual shoe may include selectable icons on the three-dimensional virtual model of the shoe. An icon may be selected or activated using a user interface on the mobile device 112.

In another example embodiment, the storage device 208 includes a primary content dataset, a contextual content dataset, and a visualization content dataset. The primary content dataset includes, for example, a first set of images and corresponding experiences (e.g., interaction with three-dimensional virtual object models). For example, an image may be associated with one or more virtual object models. The primary content dataset may include a core set of images of the most popular images determined by the server 110. The core set of images may include a limited number of images identified by the server 110. For example, the core set of images may include the images depicting covers of the ten most popular magazines and their corresponding experiences (e.g., virtual objects that represent the ten most popular magazines). In another example, the server 110 may generate the first set of images based on the most popular or often scanned images received at the server 110. Thus, the primary content dataset does not depend on objects or images scanned by the rendering module 214 of the mobile device 112.

The contextual content dataset includes, for example, a second set of images and corresponding experiences (e.g., three-dimensional virtual object models) retrieved from the server 110. For example, images captured with the mobile device 112 that are not recognized (e.g., by the server 110) in the primary content dataset are submitted to the server 110 for recognition. If the captured image is recognized by the server 110, a corresponding experience may be downloaded at the mobile device 112 and stored in the contextual content dataset. Thus, the contextual content dataset relies on the context in which the mobile device 112 has been used. As such, the contextual content dataset depends on objects or images scanned by the rendering module 214 of the mobile device 112.

In one embodiment, the mobile device 112 may communicate over the network 108 with the server 110 to retrieve a portion of a database of visual references, corresponding three-dimensional virtual objects, and corresponding interactive features of the three-dimensional virtual objects. The network 108 may be any network that enables communication between or among machines, databases, and devices (e.g., the mobile device 112). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

Any one or more of the modules described herein may be implemented using hardware (e.g., the processor 206 of a machine) or a combination of hardware and software. For example, any module described herein may configure a processor 206 to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 3 is a block diagram illustrating an example embodiment of the spatial cooperative programming language module 216 of FIG. 2. The spatial cooperative programming language module 216 includes a physical object identification module 302, a physical object state module 304, a logic module 306, a spatial visual programming module 308, and an AR programming module 310. The physical object identification module 302 identifies the physical objects 120, 122 by using computer-vision techniques. For example, each physical object may be uniquely identified based on a unique physical feature of the physical object. Each physical object 120 and 122 can have a unique shape (within the field of view of the sensors 202). For example, the physical object 120 may be a cylinder while the physical object 122 may be a cube. In another example, both physical objects 120 and 122 have the same shape (e.g., both are cubes). However, each face of the cubes has unique features (e.g., a different symbol is engraved on each face of the cubes). Other types of identification may include using QR codes, bar codes, or any unique visual or non-visual identifiers. Non-visual identifiers may include using for example, RFID, Bluetooth, or other wireless identification means.

The physical object state module 304 determines or identifies a current physical state of the physical objects 120, 122. The physical state includes a position of the physical object (e.g., located in an upper left corner of the display 204, on a physical table), a location of the physical object (e.g., physical object 120 is inside a particular room), a relative location of the physical objects (e.g., physical object 120 is “higher” than physical object 122), an orientation of the physical object (e.g., physical object 120 is a cube that has a particular face pointed up), a relative orientation (e.g., physical objects 120 and 122 point to each other, physical objects 120 and 122 are stacked on top of each other, physical objects 120 and 122 are aligned), a distance between the physical objects 120, 122 (e.g., physical object 120 and physical object 122 are one foot apart) within the field of view of the sensors 202 (or outside the field of view of the sensors 202), a context information (e.g., user profile of the user 102, credentials of the user 102, programming tasks assigned to the user 102, programming context such as type of language), an interaction between the physical objects (e.g., physical objects 120 and 122 move away from each other), an interaction between the user 102 and the physical objects 120, 122 (user pushes or taps on physical object 120), a movement of the physical objects (e.g., physical object 120 moves “up”), a direction of movement of the physical objects (e.g., physical object 120 moves along an axis, or rotates in a direction along an axis), a relative position between the mobile device 112, physical object 120, and physical object 122 (e.g., physical object 120 is to the left of the mobile device 112, physical object 122 is to the right of the mobile device 112).

The logic module 306 determines or identifies a programming logic, operation, computation, or function corresponding to an identified physical object or a group of identified physical objects based on the identity of the physical objects as determined by the physical object identification module 302 and the physical state of the physical objects as determined by the physical object state module 304.

For example, the logic module 306 retrieves or generates a first algorithm when the physical object identification module 302 identifies the physical object 120 and the physical object state module 304 determines that the physical object 120 is positioned in the middle of a physical table.

In another example, the logic module 306 retrieves a logic operator when the physical object identification module 302 identifies the physical objects 120 and 122 and the physical object state module 304 determines that the physical objects 120 and 122 are located next to each other in a top part of a physical table (as viewed by the user 102).

In another example, the logic module 306 retrieves or generates a computation algorithm when the physical object identification module 302 identifies the physical objects 120, 122, and a third physical object (not shown) and the physical object state module 304 determines that the physical objects 120 and 122 are located on the left side of a physical table (as viewed by the user 102) and the third physical object is located on the right side of the physical table. The computation algorithm is associated with the third physical object and computes data based on access to databases associated with the physical objects 120 and 122.

In another example, the logic module 306 retrieves a comparison logic when the physical object identification module 302 identifies the physical objects 120 and 122 and the physical object state module 304 determines that the physical objects 120 and 122 are stacked on top of each other.

In another example, the logic module 306 retrieves a computation algorithm or function when the physical object identification module 302 identifies the physical objects 120 and 122 and the physical object state module 304 determines that the physical objects 120 and 122 are moving away from each other.

The spatial visual programming module 308 generates augmented or virtual reality information to be displayed based on the operation, function, or logic identified by the logic module 306. For example, the spatial visual programming module 308 generates and displays a virtual connector between the physical objects 120 and 122 based on their respective identity and physical state. In another example, the spatial visual programming module 308 generates and displays a virtual connector between the physical objects 120 and 122 based on their placement or relative position to show an order of computation. Components of the spatial visual programming module 308 are described in more detail below with respect to FIG. 4.

The AR programming module 310 enables a user to assign or program a particular programming function, operation, or logic to a particular physical object based on the identity of the physical object as determined by the physical object identification module 302 and the physical state of the physical object as identified by the physical object state module 304. For example, the AR programming module 310 receives a selection of a function from a list of functions from the user 102, and assigns the selected function to the identity and physical state of the physical object 120. In another example, the AR programming module 310 receives a selection of a logic operator from a list of functions from the user 102, and assigns the selected logic operator to the identity and physical state of both the physical objects 120, 122. In another example embodiment, the programming logic affects at least one of the physical objects. For example, the programming logic can command both physical objects to move in a particular direction based on the programming logic.

FIG. 4 is a block diagram illustrating another example embodiment of the spatial visual programming module 308 of FIG. 3. The spatial visual programming module 308 includes a spatial context module 402 and a visual representation module 404. The spatial context module 402 generates virtual indicators such as visual links or connectors based on the connection as determined by programming logic associated with the identity and physical states of the physical objects. For example, the spatial context module 402 generates a virtual arrow from the physical object 120 to the physical object 122 if the results of the computation associated with the physical object 122 results in a “yes.” Other types of virtual indicators may include highlighting or emphasizing a physical object, coloring the physical object by applying a color filter, generating a cartoon animation overlaid on the physical object, or generating textual virtual information associated with the function or operation assigned to the physical object. Those of ordinary skills in the art will recognize that other types of virtual indicators can be used.

The visual representation module 404 displays the virtual indicators in the display 204 based on the virtual indicators generated by the spatial context module 402. For example, the virtual arrows connecting the physical object 120 to physical object 122 may be dynamically updated based on the new position, orientation, or location of the physical objects relative to the mobile device 112 or the stationary sensors 118.

FIG. 5 is a block diagram illustrating an example embodiment of the AR programming module 310 of FIG. 3. The AR programming module 310 includes a physical item interaction module 502 and a function assignment module 504. The physical item interaction module 502 determines the type of interaction between the user 102 and the physical object 120 (e.g., the user is tapping on the physical object 120) or between physical objects (e.g., physical object 120 is stacked on top of physical object 122). For example, the physical item interaction module 502 determines that the user is holding the physical object 120 in his right hand (within a field of view of the sensors 202) and the physical object 122 in his left hand (within the field of view of the sensors 202). In another example, the physical item interaction module 502 determines that the user has placed the physical object 120 at the center or middle of a table.

The function assignment module 504 receives a selection of a function or an operation or an identification of data or database from the user 102. The function assignment module 504 then assigns the selected function, operation, or data to the physical object and the type of interaction as determined by the physical item interaction module 502. For example, the function assignment module 504 receives a selection from the user 102 of a particular algorithm and assigns the particular algorithm to be performed when the physical object 120 is placed in the center of the table with a particular face pointing up.

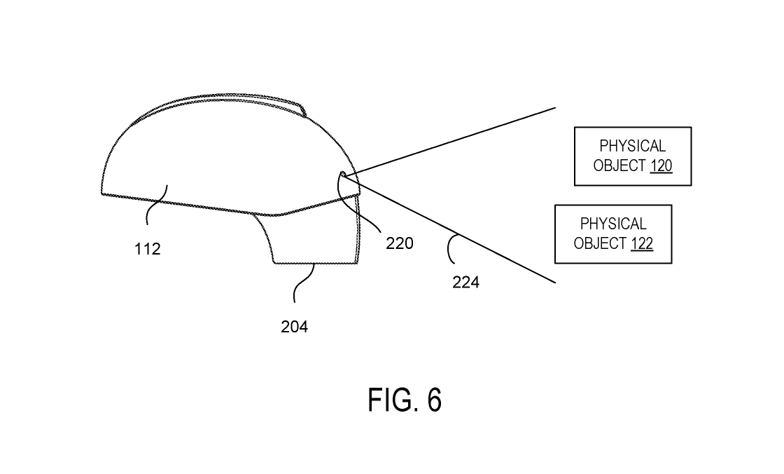

FIG. 6 is a block diagram illustrating an example embodiment of a mobile device for use of a spatial cooperative programming language. The mobile device 112 may include a helmet with a transparent visor 204. A camera 220 may be disposed in a frontal portion of the mobile device 112. The camera 220 captures an image of physical objects 120, 122 within a field of view 224.

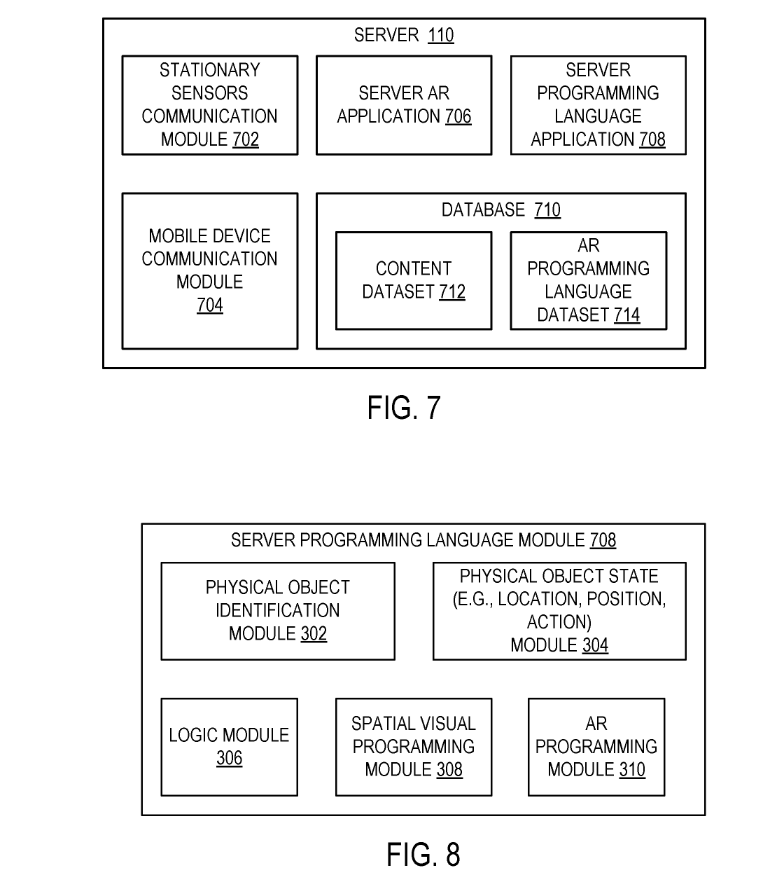

FIG. 7 is a block diagram illustrating a first example embodiment of modules (e.g., components) of the server 110. The server 110 includes a stationary sensors communication module 702, a mobile device communication module 704, a server AR application 706, a server programming language application 708, and a database 710.

The stationary sensors communication module 702 communicates, interfaces with, and accesses data from the stationary sensors 118. The mobile device communication module 704 communicates, interfaces with, and accesses data from mobile device 112. The server AR application 706 operates in a similar manner to AR application 212 of mobile device 112. The server programming language application 708 operates in a similar manner to spatial cooperative programming language module 216 of mobile device 112.

The database 710 stores a content dataset 712 and an AR programming language dataset 714. The content dataset 712 may store a primary content dataset and a contextual content dataset. The primary content dataset comprises a first set of images and corresponding virtual object models. The server AR application 706 determines that a captured image received from the mobile device 112 is not recognized in the content dataset 712, and generates the contextual content dataset for the mobile device 112. The contextual content dataset may include a second set of images and corresponding virtual object models. The virtual content dataset includes models of virtual objects to be generated upon receiving a notification associated with an image of a corresponding physical object 120.

The AR programming language dataset 714 includes identifiers (e.g., unique feature points, shapes, QR or base codes) associated with the physical objects 120, 122, their respective programming functions or operations, their respective graphical representation, and their corresponding physical states. For example, the AR programming language dataset 714 includes a database of programming functions and corresponding identification of physical objects and physical states. Pre-identified functions may be associated with a pre-identified physical object or a group of pre-identified physical objects. The pre-identified functions may further be associated with a physical spatial arrangement of the physical objects.

FIG. 8 is a block diagram illustrating an example embodiment of the server programming language module 708. The server programming language application 708 operates in a similar manner to spatial cooperative programming language module 216 of mobile device 112. For example, the server programming language application 708 includes the physical object identification module 302, the physical object state module 304, the logic module 306, the spatial visual programming module 308, and the AR programming module 310.

FIG. 9 is a flow diagram illustrating an example operation of the spatial cooperative programming language module 216 of FIG. 2. At operation 902, the spatial cooperative programming language module 216 detects a physical object near (e.g., within 5 feet or within a room) the mobile device 112. In one example, the spatial cooperative programming language module 216 can detect and identify physical objects within a field of view of optical sensors of the mobile device 112. In one example embodiment, operation 902 is implemented with the physical object identification module 302 of FIG. 3.

At operation 904, the spatial cooperative programming language module 216 identifies a state of the physical object. In one example embodiment, operation 904 is implemented with the physical object state module 304 of FIG. 3.

At operation 906, the spatial cooperative programming language module 216 determines a logic associated with the identification and state of the physical object. In one example embodiment, operation 906 is implemented with the logic module 306 of FIG. 3.

At operation 908, the spatial cooperative programming language module 216 generates augmented or virtual reality information related to the logic identified from operation 906. In one example embodiment, operation 908 is implemented with the spatial visual programming module 308 of FIG. 3.

At operation 910, the spatial cooperative programming language module 216 causes a display of the augmented or virtual reality information as connected to the physical object in the display 204 of the mobile device 112. In one example embodiment, operation 910 is implemented with the spatial visual programming module 308 of FIG. 3.

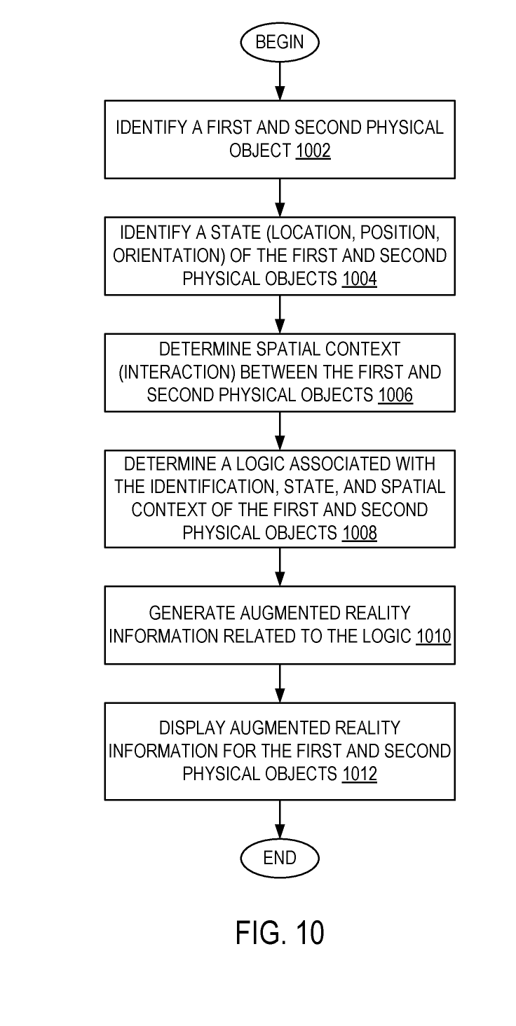

FIG. 10 is a flow diagram illustrating a first example operation of a spatial cooperative programming language module 216 of FIG. 2. At operation 1002, the spatial cooperative programming language module 216 identifies a first and second physical object within a field of view of the mobile device 112. In one example embodiment, operation 1002 is implemented with the physical object identification module 302 of FIG. 3.

At operation 1004, the spatial cooperative programming language module 216 identifies a state of the first and second physical objects. In one example embodiment, operation 1004 is implemented with the physical object state module 304 of FIG. 3.

At operation 1006, the spatial cooperative programming language module 216 determines a spatial context (e.g., interaction, relative position) between the first and second physical objects. In one example embodiment, operation 1006 is implemented with the spatial context module 402 of FIG. 4.

At operation 1008, the spatial cooperative programming language module 216 determines a logic associated with the identification and state of the physical objects, and spatial context of the physical objects. In one example embodiment, operation 1008 is implemented with the logic module 306 of FIG. 3.

At operation 1010, the spatial cooperative programming language module 216 generates augmented or virtual reality information related to the logic identified from operation 1006. In one example embodiment, operation 1010 is implemented with the spatial visual programming module 308 of FIG. 3.

At operation 1012, the spatial cooperative programming language module 216 causes a display of the augmented or virtual reality information for the first and second physical objects in the display 204 of the mobile device 112. In one example embodiment, operation 1012 is implemented with the visual representation module 404 of FIG. 4.

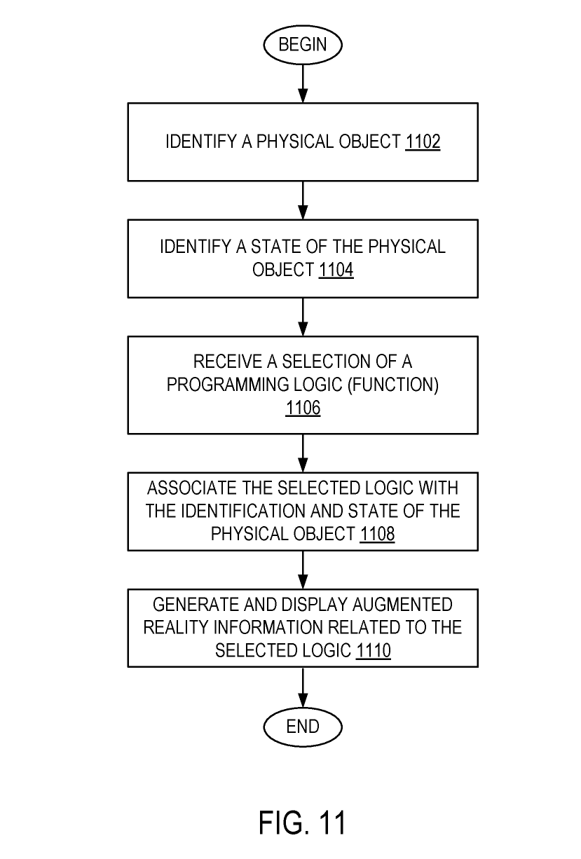

FIG. 11 is a flow diagram illustrating a second example operation of a spatial cooperative programming language module. At operation 1102, the spatial cooperative programming language module 216 identifies a physical object within a field of view of the mobile device 112. In one example embodiment, operation 1102 is implemented with the physical object identification module 302 of FIG. 3.

At operation 1104, the spatial cooperative programming language module 216 identifies a state of the physical object. In one example embodiment, operation 1104 is implemented with the physical object state module 304 of FIG. 3.

At operation 1106, the spatial cooperative programming language module 216 receives a selection of a function, a programming logic, or a computer operation from the user 102 of the mobile device 112. In one example embodiment, operation 1106 is implemented with the AR programming module 310 of FIG. 3.

At operation 1108, the spatial cooperative programming language module 216 associates the selected function, programming logic, or computer operation with the identification and state of the physical object. In one example embodiment, operation 1108 is implemented with the AR programming module 310 of FIG. 3. In another example embodiment, the programming logic affects the state of the physical objects.

At operation 1110, the spatial cooperative programming language module 216 generates and displays augmented or virtual reality information related to the selected function from operation 1108. In one example embodiment, operation 1110 is implemented with the AR programming module 310 of FIG. 3.

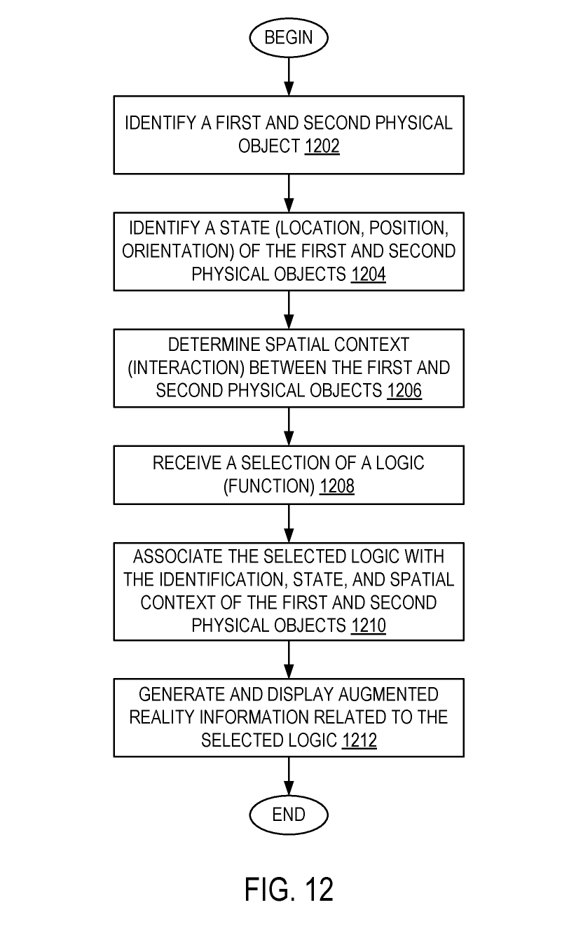

FIG. 12 is a flow diagram illustrating a third example operation of a spatial cooperative programming language module. At operation 1202, the spatial cooperative programming language module 216 identifies a first and second physical object within a field of view of the mobile device 112. In one example embodiment, operation 1202 is implemented with the physical object identification module 302 of FIG. 3.

At operation 1204, the spatial cooperative programming language module 216 identifies a state of the first and second physical object. In one example embodiment, operation 1204 is implemented with the physical object state module 304 of FIG. 3.

At operation 1206, the spatial cooperative programming language module 216 determines a spatial context (e.g., interaction, relative position) between the first and second physical objects. In one example embodiment, operation 1206 is implemented with the spatial context module 402 of FIG. 4 and the physical interaction module 502 of FIG. 5.

At operation 1208, the spatial cooperative programming language module 216 receives a selection of a function, a programming logic, or a computer operation from the user 102 of the mobile device 112. In one example embodiment, operation 1208 is implemented with the AR programming module 310 of FIG. 3. In another example embodiment, the programming logic affects the state of the physical objects.

At operation 1210, the spatial cooperative programming language module 216 associates the selected function, programming logic, or computer operation with the identification and state of the first and second physical objects. In one example embodiment, operation 1210 is implemented with the function assignment module 504 of FIG. 5.

At operation 1212, the spatial cooperative programming language module 216 generates and displays the augmented or virtual reality information related to the selected function from operation 1210. In one example embodiment, operation 1212 is implemented with the AR programming module 310 of FIG. 3.

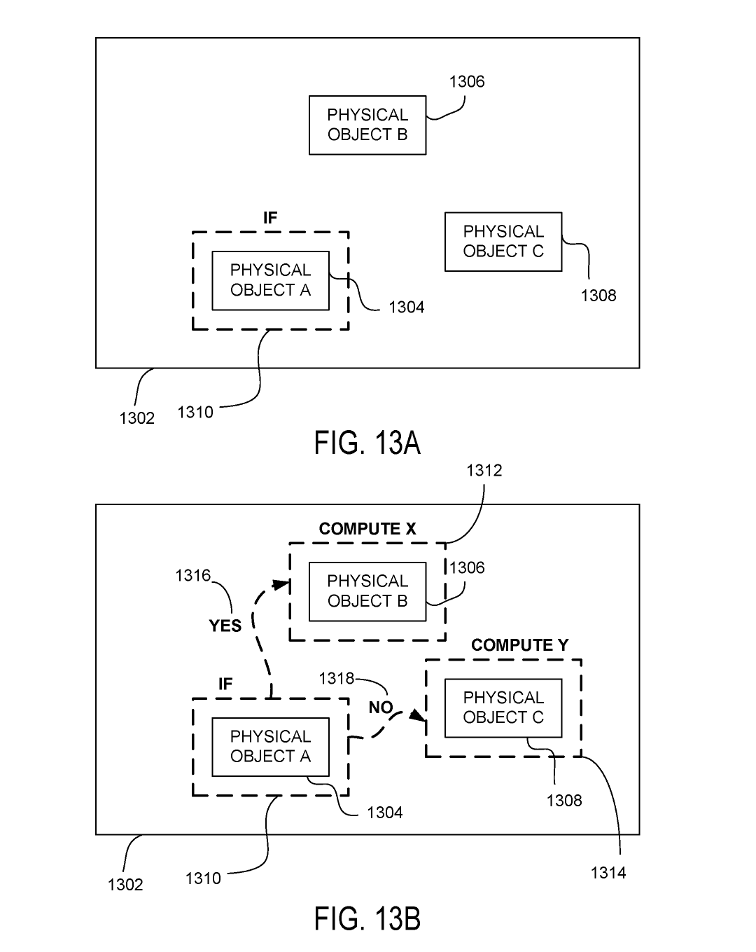

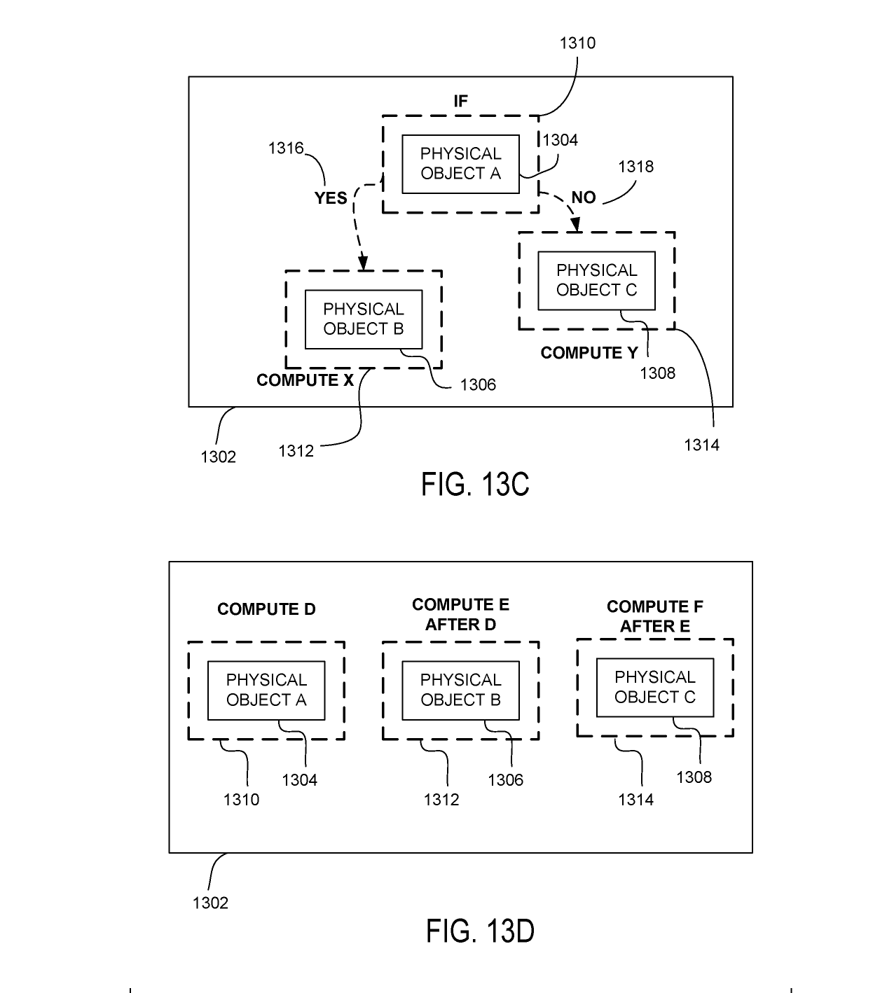

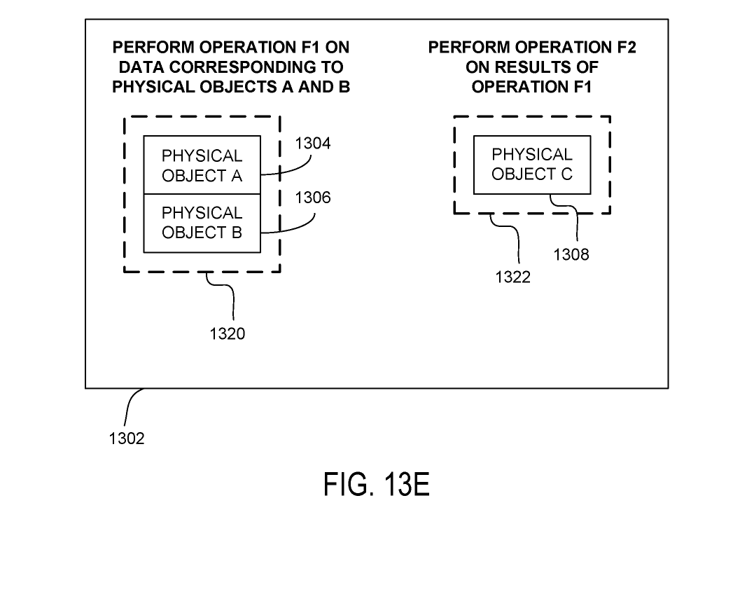

FIG. 13A is a block diagram illustrating an example of an augmented reality display generated by a spatial cooperative programming language module. Physical object A 1304, physical object B 1306, physical object C 1308 are displayed in a display 1302 or perceived by the user through a transparent display 1302. A first virtual indicator 1310 emphasizes the physical object A 1304. The first visual indicator 1310 also includes, for example, textual information (e.g., “IF”) describing a computer function associated with the physical object A 1304.

FIG. 13B is a block diagram illustrating a second example of an augmented reality display generated by a spatial cooperative programming language module. A second virtual indicator 1312 emphasizes the physical object B 1306. The second visual indicator 1312 also includes, for example, textual information (e.g., “COMPUTE X”) describing a computer function associated with the physical object B 1306. A third virtual indicator 1314 emphasizes the physical object C 1308. The third visual indicator 1314 also includes, for example, textual information (e.g., “COMPUTE Y”) describing a computer function associated with the physical object C 1308. A first visual connector 1316 displays a virtual link between the first visual indicator 1310 and the second visual indicator 1312. A second visual connector 1318 displays a virtual link between the first visual indicator 1310 and the third visual indicator 1314. The computer function associated with the physical object A may be a logic decision operator. The first visual connector 1316 illustrates a flow of a “yes” result from the logic decision operator. The second visual connector 1318 illustrates a flow of a “no” result from the logic decision operator. Those of ordinary skills in the art will recognize that other logical constructions (such as OR, XOR) may be applied.

FIG. 13C is a block diagram illustrating a third example of an augmented reality display generated by a spatial cooperative programming language module. The relative location and position of the physical objects 1304, 1306, 1308 has changed. Accordingly, the virtual indicators 1310, 1312, 1314 and visual connectors 1316, 1318 have been updated to reflect the changes in the location and position of the physical objects 1304, 1306, 1308.

FIG. 13D is a block diagram illustrating a fourth example of an augmented reality display generated by a spatial cooperative programming language module. The spatial cooperative programming language module 216 identifies and detects that the physical objects 1304, 1306, 1308 are lined up in a row. The computer function corresponding to each physical object has changed according to their new location and position (physical state). For example, physical object A 1304 is now associated with computer function “COMPUTE D” (as represented by virtual indicator 1310) instead of the “IF” logic in FIGS. 13A, 13B, and 13C. Physical object B 1306 is now associated with computer function “COMPUTE E AFTER D” (as represented by virtual indicator 1312) instead of the “COMPUTE X” logic in FIGS. 13B and 13C. Physical object C 1308 is now associated with computer function “COMPUTE F AFTER E” (as represented by virtual indicator 1314) instead of the “COMPUTE Y” logic in FIGS. 13B and 13C.

FIG. 13E is a block diagram illustrating a fifth example of an augmented reality display generated by a spatial cooperative programming language module. The spatial cooperative programming language module 216 identifies and detects that the physical objects 1304, 1306 are grouped together separate from physical object 1308. The spatial cooperative programming language module 216 further determines that the group of physical objects 1304, 1306 is located on the left side and the physical object 1308 is located on the right side.

The computer function corresponding to each physical object has changed according to their new location and position (physical state). For example, physical object A 1304 and physical object B 1306 are now associated with computer function “PERFORM OPERATION F1 ON DATA CORRESPONDING TO PHYSICAL OBJECTS A AND B” (as represented by virtual indicator 1320) instead of the “IF” and “COMPUTE X” logics in FIGS. 13B and 13C. Physical object C 1308 is now associated with computer function “PERFORM OPERATION F2 ON RESULTS OF OPERATION F1” (as represented by virtual indicator 1322) instead of the “COMPUTE Y” logics in FIGS. 13B and 13C.

### Example Machine

FIG. 14 is a block diagram illustrating components of a machine 1400, according to some example embodiments, able to read instructions 1424 from a machine-readable medium 1422 (e.g., a non-transitory machine-readable medium, a machine-readable storage medium, a computer-readable storage medium, or any suitable combination thereof) and perform any one or more of the methodologies discussed herein, in whole or in part. Specifically, FIG. 14 shows the machine 1400 in the example form of a computer system (e.g., a computer) within which the instructions 1424 (e.g., software, a program, an application, an applet, an app, or other executable code) for causing the machine 1400 to perform any one or more of the methodologies discussed herein may be executed, in whole or in part.

In alternative embodiments, the machine 1400 operates as a standalone device or may be communicatively coupled (e.g., networked) to other machines. In a networked deployment, the machine 1400 may operate in the capacity of a server machine or a client machine in a server-client network environment, or as a peer machine in a distributed (e.g., peer-to-peer) network environment. The machine 1400 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine 1400 capable of executing the instructions 1424, sequentially or otherwise, that specify actions to be taken by that machine 1400. Further, while only a single machine 1400 is illustrated, the term “machine” shall also be taken to include any collection of machines 1400 that individually or jointly execute the instructions 1424 to perform all or part of any one or more of the methodologies discussed herein.

The machine 1400 includes a processor 1402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1404, and a static memory 1406, which are configured to communicate with each other via a bus 1408. The processor 1402 contains solid-state digital microcircuits (e.g., electronic, optical, or both) that are configurable, temporarily or permanently, by some or all of the instructions 1424 such that the processor 1402 is configurable to perform any one or more of the methodologies described herein, in whole or in part. For example, a set of one or more microcircuits of the processor 1402 may be configurable to execute one or more modules (e.g., software modules) described herein. In some example embodiments, the processor 1402 is a multicore CPU (e.g., a dual-core CPU, a quad-core CPU, or a 128-core CPU) within which each of multiple cores behaves as a separate processor 1402 that is able to perform any one or more of the methodologies discussed herein, in whole or in part. Although the beneficial effects described herein may be provided by the machine 1400 with at least the processor 1402, these same beneficial effects may be provided by a different kind of machine that contains no processors 1402 (e.g., a purely mechanical system, a purely hydraulic system, or a hybrid mechanical-hydraulic system), if such a processor-less machine 1400 is configured to perform one or more of the methodologies described herein.

The machine 1400 may further include a video display 1410 (e.g., a plasma display panel (PDP), a light emitting diode (LED) display, a liquid crystal display (LCD), a projector, a cathode ray tube (CRT), or any other display capable of displaying graphics or video). The machine 1400 may also include an alphanumeric input device 1412 (e.g., a keyboard or keypad), a cursor control device 1414 (e.g., a mouse, a touchpad, a trackball, a joystick, a motion sensor, an eye tracking device, or other pointing instrument), a drive unit 1416, an signal generation device 1418 (e.g., a sound card, an amplifier, a speaker, a headphone jack, or any suitable combination thereof), and a network interface device 1420.

The drive unit 1416 (e.g., a data storage device 208) includes the machine-readable medium 1422 (e.g., a tangible and non-transitory machine-readable storage medium) on which are stored the instructions 1424 embodying any one or more of the methodologies or functions described herein. The instructions 1424 may also reside, completely or at least partially, within the main memory 1404, within the processor 1402 (e.g., within the processor's cache memory), or both, before or during execution thereof by the machine 1400. Accordingly, the main memory 1404 and the processor 1402 may be considered machine-readable media 1422 (e.g., tangible and non-transitory machine-readable media). The instructions 1424 may be transmitted or received over the network 1426 via the network interface device 1420. For example, the network interface device 1420 may communicate the instructions 1424 using any one or more transfer protocols (e.g., hypertext transfer protocol (HTTP)).

In some example embodiments, the machine 1400 may be a portable computing device (e.g., a smart phone, tablet computer, or a wearable device), and have one or more additional input components (e.g., sensors 202 or gauges). Examples of such input components include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a biometric input component (e.g., a heartrate detector or a blood pressure detector), and a gas detection component (e.g., a gas sensor). Input data gathered by any one or more of these input components may be accessible and available for use by any of the modules described herein.

As used herein, the term “memory” refers to a machine-readable medium 1422 able to store data temporarily or permanently and may be taken to include, but not be limited to, random-access memory (RAM), read-only memory (ROM), buffer memory, flash memory, and cache memory. While the machine-readable medium 1422 is shown, in an example embodiment, to be a single medium, the term “machine-readable medium” should be taken to include a single medium or multiple media (e.g., a centralized or distributed database, or associated caches and servers 110) able to store instructions 1424. The term “machine-readable medium” shall also be taken to include any medium, or combination of multiple media, that is capable of storing the instructions 1424 for execution by the machine 1400, such that the instructions 1424, when executed by one or more processors of the machine 1400 (e.g., processor 1402), cause the machine 1400 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof. A “non-transitory” machine-readable medium, as used herein, specifically does not include propagating signals per se. In some example embodiments, the instructions 1424 for execution by the machine 1400 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 1424).

### Example Mobile Device

FIG. 15 is a block diagram illustrating a mobile device 1500, according to an example embodiment. The mobile device 1500 may include a processor 1502. The processor 1502 may be any of a variety of different types of commercially available processors 1502 suitable for mobile devices 1500 (for example, an XScale architecture microprocessor, a microprocessor without interlocked pipeline stages (MIPS) architecture processor, or another type of processor 1502). A memory 1504, such as a random access memory (RAM), a flash memory, or other type of memory, is typically accessible to the processor 1502. The memory 1504 may be adapted to store an operating system (OS) 1506, as well as application programs 1508, such as a mobile location enabled application that may provide LBSs to a user 102. The processor 1502 may be coupled, either directly or via appropriate intermediary hardware, to a display 1510 and to one or more input/output (I/O) devices 1512, such as a keypad, a touch panel sensor, a microphone, and the like. Similarly, in some embodiments, the processor 1502 may be coupled to a transceiver 1514 that interfaces with an antenna 1516. The transceiver 1514 may be configured to both transmit and receive cellular network signals, wireless data signals, or other types of signals via the antenna 1516, depending on the nature of the mobile device 1500. Further, in some configurations, a GPS receiver 1518 may also make use of the antenna 1516 to receive GPS signals.

Certain example embodiments are described herein as including modules. Modules may constitute software modules (e.g., code stored or otherwise embodied in a machine-readable medium 1422 or in a transmission medium), hardware modules, or any suitable combination thereof. A “hardware module” is a tangible (e.g., non-transitory) physical component (e.g., a set of one or more processors 1402) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor 1402. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors 1402, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over suitable circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory 1404 (e.g., a memory device) to which it is communicatively coupled. A further hardware module may then, at a later time, access the memory 1404 to retrieve and process the stored output. Hardware modules may also initiate communications with input or output devices, and can operate on a resource (e.g., a collection of information from a computing resource).

The various operations of example methods described herein may be performed, at least partially, by one or more processors 1402 that are temporarily configured (e.g., by software) or permanently configured to perform the relevant operations. Whether temporarily or permanently configured, such processors 1502 may constitute processor-implemented modules that operate to perform one or more operations or functions described herein. As used herein, “processor-implemented module” refers to a hardware module in which the hardware includes one or more processors 1402. Accordingly, the operations described herein may be at least partially processor-implemented, hardware-implemented, or both, since a processor 1402 is an example of hardware, and at least some operations within any one or more of the methods discussed herein may be performed by one or more processor-implemented modules, hardware-implemented modules, or any suitable combination thereof.

Moreover, such one or more processors 1402 may perform operations in a “cloud computing” environment or as a service (e.g., within a “software as a service” (SaaS) implementation). For example, at least some operations within any one or more of the methods discussed herein may be performed by a group of computers (e.g., as examples of machines 1400 that include processors 1402), with these operations being accessible via a network 1426 (e.g., the Internet) and via one or more appropriate interfaces (e.g., an application program interface (API)). The performance of certain operations may be distributed among the one or more processors 1402, whether residing only within a single machine 1400 or deployed across a number of machines 1400. In some example embodiments, the one or more processors 1402 or hardware modules (e.g., processor-implemented modules) may be located in a single geographic location (e.g., within a home environment, an office environment, or a server farm). In other example embodiments, the one or more processors 1402 or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory 1404 (e.g., a computer memory 1404 or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 1200. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine 1400 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated embodiments describe various example embodiments of methods, machine-readable media 1422, and systems (e.g., machines 1400, devices, or other apparatus) discussed herein.

A first embodiment provides a device comprising:

a sensor configured to detect a first physical object and a second physical object;
a display; and
one or more processors comprising an augmented reality (AR) application,
the AR application configured to identify the first and second physical objects and a physical state of the first and second physical objects, to generate a programming logic associated with the identification and physical state of the first and second physical objects, to generate augmented or virtual reality information related to the programming logic, and to display the augmented or virtual reality information in the display.

A second embodiment provides a device according to the first embodiment, wherein the physical state of the first physical object includes an identification of a first location of the first physical object, a first relative position of the first physical object with respect to the second physical object, and a first interaction of a user of the device with the first physical object, the first physical object not electronically connected to the second physical object and the device, and

wherein the physical state of the second physical object includes an identification of a second location of the second physical object, a second relative position of the second physical object with respect to the first physical object, and a second interaction of the user of the device with the second physical object, the second physical object not electronically connected to the first physical object and the device.

A third embodiment provides a device according to the first embodiment, wherein the first or second interaction includes a motion of the first or second physical object in a direction and a rotation of the first or second physical object along an axis, the programming logic based on the motion and the rotation of the first and second physical objects.

A fourth embodiment provides a device according to the first embodiment, wherein the physical state identifies that the first physical object is aligned with the second physical object along an axis, the programming logic based on the alignment of the first and second physical object along the axis.

A fifth embodiment provides a device according to the first embodiment, wherein the physical state identifies that the first physical object is grouped with the second physical object based on the distance between the first and the second physical object being within a threshold distance, and wherein the AR application is configured to generate a second programming logic based on the grouping of the first and second physical object.

A sixth embodiment provides a device according to the fifth embodiment, wherein the sensor comprises an optical sensor configured to capture an image of the first and second physical object and a third physical object within a same field of view, and wherein the AR application is configured to generate a third programming logic associated with the identification and the physical state of the third physical object, and the distance between the third physical object exceeding the threshold distance, the third programming logic configured to perform an operation on a result of the second programming logic.

A seventh embodiment provides a device according to the first embodiment, wherein the augmented or virtual reality information includes a visual link between the first and second physical object, textual information related to the programming logic of the first and second physical objects and to the visual link.

An eighth embodiment provides a device according to the seventh embodiment, wherein the AR application dynamically updates the augmented or virtual reality information based on the physical states of the first and second physical objects and a contextual information of the first and second physical objects, the contextual information comprising a user profile, a location of the device, and a task selected by a user of the device.

A ninth embodiment provides a device according to the first embodiment, wherein AR application is configured to:

receive a selection of a first programming logic for the first physical object from a user of the device, a selection of a second programming logic for the second physical object from the user of the device,
associate the first programming logic with the identification of the first physical object and a physical state of the first physical object,
associate the second programming logic with the identification of the second physical object and a physical state of the second physical object,
generate a first augmented or virtual reality visual indicator associated with the first programming logic and display the first augmented or virtual reality visual indicator in the display, the first augmented or virtual reality visual indicator perceived by the user of the device as displayed next to the first physical object, and
generate a second augmented or virtual reality visual indicator associated with the second programming logic and display the second augmented or virtual reality visual indicator in the display, the second augmented or virtual reality visual indicator perceived by the user of the device as displayed next to the second physical object.

A tenth embodiment provides a device according to the first embodiment, wherein the first and second physical objects include non-electric physical objects, wherein the programming logic includes an operator of a programming language.

An eleventh embodiment provides a method (e.g., a spatial cooperative programming language) comprising:

detecting a first physical object and a second physical object with a sensor of a device;
identifying, using an augmented reality application implemented in a hardware processor of the device, the first and second physical objects and a physical state of the first and second physical objects;
generating a programming logic associated with the identification and physical state of the first and second physical objects;
generating augmented or virtual reality information related to the programming logic; and
displaying the augmented or virtual reality information in a display of the device.

A twelfth embodiment provides a method according to the eleventh embodiment, wherein the physical state of the first physical object includes an identification of a first location of the first physical object, a first relative position of the first physical object with respect to the second physical object, and a first interaction of a user of the device with the first physical object, the first physical object not electronically connected to the second physical object and the device, and

wherein the physical state of the second physical object includes an identification of a second location of the second physical object, a second relative position of the second physical object with respect to the first physical object, and a second interaction of the user of the device with the second physical object, the second physical object not electronically connected to the first physical object and the device.

A thirteenth embodiment provides a method according to the eleventh embodiment, wherein the first or second interaction includes a motion of the first or second physical object in a direction and a rotation of the first or second physical object along an axis, the programming logic based on the motion and the rotation of the first and second physical objects.

A fourteenth embodiment provides a method according to the eleventh embodiment, wherein the physical state identifies that the first physical object is aligned with the second physical object along an axis, the programming logic based on the alignment of the first and second physical object along the axis.

A fifteenth embodiment provides a method according to the eleventh embodiment, wherein the physical state identifies that the first physical object is grouped with the second physical object based on the distance between the first and the second physical object being within a threshold distance, and

wherein the method further comprises generating a second programming logic based on the grouping of the first and second physical object.

A sixteenth embodiment provides a method according to the eleventh embodiment, further comprising:

capturing an image of the first and second physical object and a third physical object within a same field of view of anoptical sensor; and
generating a third programming logic associated with the identification and the physical state of the third physical object, and the distance between the third physical object exceeding the threshold distance, the third programming logic configured to perform an operation on a result of the second programming logic.

A seventeenth embodiment provides a method according to the eleventh embodiment, wherein the augmented or virtual reality information includes a visual link between the first and second physical object, textual information related to the programming logic of the first and second physical objects and to the visual link.

An eighteenth embodiment provides a method according to the eleventh embodiment, further comprising:

dynamically updating the augmented or virtual reality information based on the physical states of the first and second physical objects and a contextual information of the first and second physical objects, the contextual information comprising a user profile, a location of the device, and a task selected by a user of the device.

A nineteenth embodiment provides a method according to the eleventh embodiment, further comprising:

receiving a selection of a first programming logic for the first physical object from a user of the device, a selection of a second programming logic for the second physical object from the user of the device;
associating the first programming logic with the identification of the first physical object and a physical state of the first physical object;
associating the second programming logic with the identification of the second physical object and a physical state of the second physical object;
generating a first augmented reality visual indicator associated with the first programming logic and display the first augmented reality visual indicator in the display, the first augmented reality visual indicator perceived by the user of the device as displayed next to the first physical object; and
generating a second augmented reality visual indicator associated with the second programming logic and display the second augmented reality visual indicator in the display, the second augmented reality visual indicator perceived by the user of the device as displayed next to the second physical object.

What is claimed is:

1. A device comprising:
a sensor configured to detect a first physical object and a second physical object;
a display; and
one or more processors comprising an augmented reality (AR) application,
the AR application configured to identify the first and second physical objects and a physical state of the first and second physical objects, to generate a programming logic associated with the identification and physical state of the first and second physical objects, to generate augmented reality information related to the programming logic, and to display the augmented reality information in the display.

2. The device of claim 1, wherein the physical state of the first physical object includes an identification of a first location of the first physical object, a first relative position of the first physical object with respect to the second physical object, and a first interaction of a user of the device with the first physical object, the first physical object not electronically connected to the second physical object and the device, and
wherein the physical state of the second physical object includes an identification of a second location of the second physical object, a second relative position of the second physical object with respect to the first physical object, and a second interaction of the user of the device with the second physical object, the second physical object not electronically connected to the first physical object and the device.

3. The device of claim 1, wherein the first or second interaction includes a motion of the first or second physical object in a direction and a rotation of the first or second physical object along an axis, the programming logic based on the motion and the rotation of the first and second physical objects.

4. The device of claim 1, wherein the physical state identifies that the first physical object is aligned with the second physical object along an axis, the programming logic based on the alignment of the first and second physical object along the axis.

5. The device of claim 1, wherein the physical state identifies that the first physical object is grouped with the second physical object based on the distance between the first and the second physical object being within a threshold distance, and
wherein the AR application is configured to generate a second programming logic based on the grouping of the first and second physical object.

6. The device of claim 5, wherein the sensor comprises an optical sensor configured to capture an image of the first and second physical object and a third physical object within a same field of view, and
wherein the AR application is configured to generate a third programming logic associated with the identification and the physical state of the third physical object, and the distance between the third physical object exceeding the threshold distance, the third programming logic configured to perform an operation on a result of the second programming logic.

7. The device of claim 1, wherein the augmented reality information includes a visual link between the first and second physical object, textual information related to the programming logic of the first and second physical objects and to the visual link.

8. The device of claim 7, wherein the AR application dynamically updates the augmented reality information based on the physical states of the first and second physical objects and a contextual information of the first and second physical objects, the contextual information comprising a user profile, a location of the device, and a task selected by a user of the device.

9. The device of claim 1, wherein the AR application is configured to:
receive a selection of a first programming logic for the first physical object from a user of the device, a selection of a second programming logic for the second physical object from the user of the device,
associate the first programming logic with the identification of the first physical object and a physical state of the first physical object,
associate the second programming logic with the identification of the second physical object and a physical state of the second physical object,
generate a first augmented reality visual indicator associated with the first programming logic and display the first augmented reality visual indicator in the display, the first augmented reality visual indicator perceived by the user of the device as displayed next to the first physical object, and
generate a second augmented reality visual indicator associated with the second programming logic and display the second augmented reality visual indicator in the display, the second augmented reality visual indicator perceived by the user of the device as displayed in relation to the second physical object.

10. The device of claim 1, wherein the first and second physical objects include non-electric physical objects, wherein the programming logic includes an operator of a programming language, wherein the programming logic affects at least one of the first and second physical objects.

11. A method comprising:
detecting a first physical object and a second physical object with a device;
identifying, using an augmented reality application implemented in a hardware processor of the device, the first and second physical objects and a physical state of the first and second physical objects;
generating a programming logic associated with the identification and physical state of the first and second physical objects;
generating augmented reality information related to the programming logic; and
displaying the augmented reality information in a display of the device.

12. The method of claim 11, wherein the physical state of the first physical object includes an identification of a first location of the first physical object, a first relative position of the first physical object with respect to the second physical object, and a first interaction of a user of the device with the first physical object, the first physical object not electronically connected to the second physical object and the device, and
wherein the physical state of the second physical object includes an identification of a second location of the second physical object, a second relative position of the second physical object with respect to the first physical object, and a second interaction of the user of the device with the second physical object, the second physical object not electronically connected to the first physical object and the device.

13. The method of claim 11, wherein the first or second interaction includes a motion of the first or second physical object in a direction and a rotation of the first or second physical object along an axis, the programming logic based on the motion and the rotation of the first and second physical objects.

14. The method of claim 11, wherein the physical state identifies that the first physical object is aligned with the second physical object along an axis, the programming logic based on the alignment of the first and second physical object along the axis.

15. The method of claim 11, wherein the physical state identifies that the first physical object is grouped with the second physical object based on the distance between the first and the second physical object being within a threshold distance, and
wherein the method further comprises generating a second programming logic based on the grouping of the first and second physical object.

16. The method of claim 15, further comprising:
capturing an image of the first and second physical object and a third physical object within a same field of view of anoptical sensor of the device; and
generating a third programming logic associated with the identification and the physical state of the third physical object, and the distance between the third physical object exceeding the threshold distance, the third programming logic configured to perform an operation on a result of the second programming logic.

17. The method of claim 11, wherein the augmented reality information includes a visual link between the first and second physical object, textual information related to the programming logic of the first and second physical objects and to the visual link.

18. The method of claim 17, further comprising:
dynamically updating the augmented reality information based on the physical states of the first and second physical objects and a contextual information of the first and second physical objects, the contextual information comprising a user profile, a location of the device, and a task selected by a user of the device; and
updating a state of at least one of the first and second physical objects based on the programming logic.

19. The method of claim 11, further comprising:
receiving a selection of a first programming logic for the first physical object from a user of the device, a selection of a second programming logic for the second physical object from the user of the device;
associating the first programming logic with the identification of the first physical object and a physical state of the first physical object;
associating the second programming logic with the identification of the second physical object and a physical state of the second physical object;
generating a first augmented reality visual indicator associated with the first programming logic and display the first augmented reality visual indicator in the display, the first augmented reality visual indicator perceived by the user of the device as displayed next to the first physical object; and
generating a second augmented reality visual indicator associated with the second programming logic and display the second augmented reality visual indicator in the display, the second augmented reality visual indicator perceived by the user of the device as displayed in relation to the second physical object.

20. A non-transitory machine-readable medium comprising instructions that, when executed by one or more processors of a machine, cause the machine to perform operations comprising:
detecting a first physical object and a second physical object with a sensor of a device;
identifying, using an augmented reality application implemented in a hardware processor of the device, the first and second physical objects and a physical state of the first and second physical objects;
generating a programming logic associated with the identification and physical state of the first and second physical objects;
generating augmented reality information related to the programming logic; and
displaying the augmented reality information in a display of the device.
